(19) United States
(12) Patent Application Publication
(10) Pub. No.: US 2024/0397967 A1
(43) Pub. Date: Dec. 5, 2024

(54) OIL-AND/OR-FAT COMPOSITION FOR COOKING RICE, COOKED RICE, AND METHOD FOR MANUFACTURING COOKED RICE

(71) Applicant: The Nisshin OilliO Group, Ltd., Tokyo (JP)

(72) Inventors: Takahiro Okada, Yokohama-shi (JP); Taeko Tanaka, Yokohama-shi (JP); Miyuki Yabuki, Yokohama-shi (JP)

(21) Appl. No.: 18/699,173

(22) PCT Filed: Oct. 12, 2022
(86) PCT No.: PCT/JP2022/038118

§ 371 Date: Apr. 5, 2024

(30) Foreign Application Priority Data
Oct. 12, 2021 (JP) 2021-167524

(51) Int. Cl. A23D 9/013; A23L 7/196

(52) U.S. Cl. CPC A23D 9/013; A23L 7/1965

(57) ABSTRACT

A rice cooking oil that suppresses the stickiness of cooked rice; cooked rice having suppressed stickiness; and a method for manufacturing cooked rice having suppressed stickiness. An oil-and/or-fat composition for cooking rice containing 2 to 14 mass % of a triglyceride in which the constituent fatty acid is a medium chain fatty acid, and 0.6 to 4 mass % of a polyglycerol fatty acid ester. The medium chain fatty acid is a straight chain saturated fatty acid having 6 to 12 carbon atoms.

### TECHNICAL FIELD

The present invention relates to an oil for rice cooking that suppresses stickiness of cooked rice, cooked rice with reduced stickiness, and a method of manufacturing cooked rice.

### BACKGROUND ART

Taste of cooked rice depends on sweetness, stickiness, hardness, and the like of the cooked rice, and particularly, higher stickiness or the like is often highly appreciated. However, when cooked rice is eaten at low temperature, for example, a rice ball or white rice of a boxed lunch is eaten, there was an issue that not only cooked rice grains themselves become hard, but also disintegrability of a lump of the cooked rice during mastication is poor due to influence of stickiness of the cooked rice; thus the cooked rice is perceived as harder. For this reason, in order to improve texture of cooked rice at a low temperature even a little, there has been a need for less sticky cooked rice. On the other hand, in order to improve looseness, matte, flavor, and the like of cooked rice, a edible oil is added to raw rice immersed in water, when cooking rice. In order to obtain these effects sufficiently, it is necessary to uniformly disperse an edible oil having poor affinity for water and a method of adding an emulsifier such as a polyglycerin fatty acid ester to the edible oil (Patent Document 1) has been proposed. Further, rice cooking oils containing 15 to 99.9% by mass of a triglyceride having a medium chain fatty acid as a constituent fatty acid and 0.1 to 3% by mass of polyglycerin fatty acid ester have been proposed (Patent Document 2). Although these rice cooking oils reduce adhesion between cooked rice grains, since the adhesion between cooked rice grains and the stickiness of cooked rice (lump) do not necessarily coincide with each other, so that the problems cannot be immediately solved by these rice cooking oils.
Patent Document 1: Japanese Unexamined Patent Application, Publication No. 2002-153209
Patent Document 2: Japanese Unexamined Patent Application, Publication No. 2018-108052

### DISCLOSURE OF THE INVENTION

### Problems to be Solved by the Invention

An object of the present invention is to provide an oil for cooking rice that suppresses stickiness of cooked rice, cooked rice with reduced stickiness, and a manufacturing method of cooked rice with reduced stickiness.

### Means for Solving the Problems

As a result of extensive investigations, the present inventors have found that by blending a specific amount of a specific triglyceride and a specific amount of a polyglycerin fatty acid ester, it is possible to suppress the stickiness of cooked rice, arriving at the completion of the present invention.

That is, the present invention provides the following [1] to [8].

[1] A fat and/or oil composition for rice cooking, including 2 to 14% by mass of a triglyceride and 0.6 to 4% by mass of a polyglycerin fatty acid ester,
in which the triglyceride includes at least one medium chain fatty acid as a constituent fatty acid and
the at least one medium chain fatty acid is a linear saturated fatty acid having 6 to 12 carbon atoms.

[2] The fat and/or oil composition for rice cooking as described in [1], in which the polyglycerin fatty acid ester is a polyglycerin fatty acid ester having an HLB of 3 to 8.

[3] The fat and/or oil composition for rice cooking as described in [1] or [2], in which 50% by mass or more of the constituent fatty acid of the polyglycerin fatty acid ester is an unsaturated fatty acid having 16 to 22 carbon atoms and/or the constituent polyglycerin has a degree of polymerization of 4 to 12.

[4] The fat and/or oil composition for rice cooking as described in any one of [1] to [3], in which the at least one medium chain fatty acid consists of a linear saturated fatty acid having 8 carbon atoms and/or a linear saturated fatty acid having 10 carbon atoms.

[5] The fat and/or oil composition for rice cooking as described in any one of [1] to [4], in which the fat and/or oil in the fat and/or oil composition for rice cooking is liquid at 10° C.

[6] The fat and/or oil composition for rice cooking as described in any one of [1] to [5], in which the fat and/or oil composition for rice cooking is for cooked rice.

[7] Cooked rice including the fat and/or oil composition for rice cooking as described in any one of [1] to [6].

[8] A method for producing cooked rice, including adding 0.1 to 5% by mass of the fat and/or oil composition for rice cooking as described in any one of [1] to [6] to raw cereals before being cooked.

### Effects of the Invention

According to the present invention, it is possible to provide cooked rice with reduced stickiness, and improve texture and flavor of the cooked rice in a cooled state (room temperature).

### PREFERRED MODE FOR CARRYING OUT THE INVENTION

Hereinafter, the present invention will be described in detail. In the embodiments of the present invention, A (numerical value) to B (numerical value) means A or more and B or less. Note that the preferred embodiments, more preferred embodiments, and the like exemplified below can be appropriately combined with each other regardless of expressions such as “preferably” and “more preferably”. Further, description of numerical ranges is an example, and a range in which the upper limit and the lower limit of each range and numerical values disclosed in the Examples are appropriately combined can also be preferably used regardless of expressions such as “preferably” and “more preferably”. Further, the terms “comprising” and “including” may be interpreted as “essentially consisting” or “consisting of”.

[Fat and/or Oil Composition for Rice Cooking]
<Fat and/or Oil>

The fat and/or oil composition for rice cooking of the present invention includes 2 to 14% by mass of a triglyceride including at least one medium chain fatty acid as a constituent fatty acid. Note that the medium chain fatty acid is a linear saturated fatty acid having 6 to 12 carbon atoms. Examples of the medium chain fatty acid include caproic acid, caprylic acid, capric acid, and lauric acid, but linear saturated fatty acids having 6 to 10 carbon atoms are preferable, because they have a low melting point and are liquid or easily change to liquid. Meanwhile, since a triglyceride including a medium-chain fatty acid having a small number of carbon atoms may cause irritation to the throat or stomach of some persons after eating, the linear saturated fatty acid has preferably 8 or more carbon atoms and more preferably 10 or more carbon atoms. It is particularly preferable for the at least one medium chain fatty acid constituting the triglyceride to consist of a linear saturated fatty acid having 8 carbon atoms and/or a linear saturated fatty acid having 10 carbon atoms.

While the fat and/or oil composition for rice cooking of the present invention includes 2 to 14% by mass of a triglyceride including a medium chain fatty acid as a constituent fatty acid, if the triglyceride is present in a content of 2% by mass or more, it is possible to obtain cooked rice with reduced stickiness by adding a polyglycerin fatty acid ester, which is described later. When the content is 14% by mass or less, it is possible to obtain cooked rice having an appropriate stickiness while suppressing the stickiness. The fat and/or oil composition for rice cooking of the present invention preferably contains 4 to 14% by mass, more preferably 5 to 12% by mass, and most preferably 8 to 12% by mass of a triglyceride including a medium chain fatty acid as a constituent fatty acid.

As the triglyceride including at least one medium chain fatty acid as a constituent fatty acid, it is possible to use a triglyceride obtained by dehydration-condensation of a medium chain fatty acid and glycerol, or a triglyceride obtained by transesterification between an alkyl ester of a medium chain fatty acid and glycerin. A commercially available triglyceride can be used as the medium chain fatty acid triglyceride (MCT). In addition, likewise to MCT, it is possible to use a triglyceride obtained by dehydration-condensation of a medium chain fatty acid, a fatty acid having 14 to 22 carbon atoms, and glycerol, or a triglyceride obtained by transesterification between an alkyl ester of the above-mentioned fatty acids and glycerol. Further, refined fats and/or oils subjected to at least a deodorization step are preferred.

The “fat and/or oil composition for rice cooking” of the present invention may further include any other fat and/or oil raw material as long as the content of the triglyceride including a medium-chain fatty acid as the constituent fatty acid satisfies the above-mentioned specific range. An animal or vegetable oil also can be used. Examples thereof include: vegetable fats and/or oils, such as soybean oil, canola oil, cottonseed oil, sunflower oil, safflower oil, corn oil, rice oil, sesame oil, olive oil, perilla oil, linseed oil, peanut oil, grape seed oil, coconut oil, palm kernel oil, palm oil, or the like; and animal oils, such as milk fats, lard or the like. These can be used alone or in combination of two or more types. Further, the following oils can be used: a fractional oil of a vegetable oil, such as palm olein, palm super olein, a palm mid fraction, palm stearin, or the like; a transesterification oil based on fats and/or oils or a fat and/or oil and a lower alcohol fatty acid ester as raw materials; or the like. Note that as the transesterification oil, those obtained by fractionation after transesterification can also be used. Fats and/or oils which are liquid at 10° C. are preferred, and refined fats and oils which have been subjected to at least a deodorizing step are preferred.

When the fat and/or oil composition for rice cooking of the present invention includes a vegetable oil, the content of the vegetable oil is preferably 82 to 97.4% by mass, more preferably 85 to 94.3% by mass, and most preferably 86 to 91.2% by mass. In the present invention, the fat and/or oil composition for rice cooking includes a triglyceride including a medium chain fatty acid as a constituent fatty acid and a polyglycerin fatty acid ester, whereby it is possible to suppress flavor of the vegetable oil from deteriorating due to rice cooking.

### <Polyglycerin Fatty Acid Ester>

The fat and/or oil composition for rice cooking of the present invention includes 0.6 to 4% by mass of a polyglycerin fatty acid ester. In this range, it is possible to obtain cooked rice having an appropriate stickiness while suppressing stickiness, and further, the flavor of the cooked rice is good. The blending amount of the polyglycerin fatty acid ester is preferably from 0.7 to 3% by mass and more preferably from 0.8 to 2% by mass in the fat and/or oil composition for rice cooking of the present invention.

The polyglycerin fatty acid ester used in the fat and/or oil composition for rice cooking of the present invention preferably has an HLB of 3 to 8, from the viewpoint of solubility of the fat and/or oil composition for rice cooking in oil and dispersibility thereof in water, during rice cooking. Note that the HLB is an abbreviation of hydrophilic hydrophobic balance, serves as an index for knowing whether an emulsifier is hydrophilic or lipophilic, and has a value of 0 to 20. The smaller the HLB value, the stronger the lipophilicity. In the present invention, the HLB value is calculated by an atlas method. The calculating method of the atlas method refers to a method to calculate an HLB value from the following formula:

$$HLB = 20 \times ( 1 - S / A )$$

S: saponification value, and
A: neutralization value of fatty acid in the ester.

Because the fat and/or oil composition for rice cooking tends to be liquid, the polyglycerin fatty acid ester used in the fat and/or oil composition for rice cooking of the present invention is preferable that 50% by mass or more of the constituent fatty acid is an unsaturated fatty acid having 16 to 22 carbon atoms and it is more preferable for the unsaturated fatty acid to be oleic acid, linoleic acid, linolenic acid, or erucic acid. From the viewpoint of oxidation stability, oleic acid and erucic acid are more preferable. For example, oleic acid ester of pentaglicerin, oleic acid ester of decaglycerin, or the like can be used.

For the polyglycerin fatty acid ester used in the fat and/or oil composition for rice cooking of the present invention, a constituent polyglycerin moiety may include polyglycerin with various degrees of polymerization. Preferably, a fatty acid ester of polyglycerin with an average degree of polymerization of 4 or more (tetrapolyglycerin) is used. Further, it is more preferable to use a fatty acid ester of polyglycerin having an average degree of polymerization of 4 to 40 and it is most preferable to use a fatty acid ester of polyglycerin having an average polymerization degree of 4 to 12.

In addition to the above-described components, the fat and/or oil composition for rice cooking of the present invention may include a raw material that is generally blended in fat and/or oil compositions for rice cooking. Specifically, for example, a pH adjusting agent, a seasoning agent, a coloring agent, a flavor, an antioxidant, a sugar, a sugar alcohol, a stabilizer, an emulsifier, or the like may be used. Amounts of these components may be any amount as long as the effect of the present invention is not impaired, but may be, for example, 10% by mass or less, preferably 0 to 3% by mass, and more preferably 0 to 1% by mass in the fat and/or oil composition for rice cooking.

### [Cooked Rice and Method of Manufacturing Same]

The cooked rice of the present invention is characterized by including the aforementioned fat and/or oil composition for rice cooking.

### <Raw Cereals Before Rice Cooking>

As raw cereals to be used in the present invention, rice, millet, Japanese millet, quinoa, and wheat can be used. Rice, millet, Japanese millet, and wheat are generally threshed. Since suppressing stickiness of cooked rice is one of the purposes of using the fat and/or oil composition for rice cooking, the raw cereals preferably include 50 mass& or more of raw rice, which has stickiness, and more preferably all is raw rice. There are no particular limitations on the type and production area of the raw rice. For example, not only japonica rice, indica rice, and javanica rice, but also hybridization of these rices or the like can be used. In addition, a degree of milling of raw rice is not particularly limited. Not only white rice but brown rice, half-milled rice, germinated brown rice, rinse-free rice or the like also can be used in the present invention.

### <Rice Cooking>

In the present invention, the fat and/or oil composition for rice cooking described in the section [Fat and/or Oil Composition for Rice Cooking] above is added to the raw cereals and water before cooking. The order of adding the raw cereals, water, and the fat and/or oil composition for rice cooking is not particularly limited. The obtained mixture may be stirred after addition, but it is preferable not to strongly stir the mixture, because the raw cereals may be broken. The fat and/or oil composition for rice cooking of the present invention is added in an amount of 0.1 to 5% by mass based on the raw cereals before cooking. In this range, cooked rice having excellent looseness and flavor can be obtained. The content is more preferably 0.3 to 2% by mass and most preferably 0.5 to 1.5% by mass. An amount of water, heating temperature, heating time, or the like at the time of cooking are the same as those of ordinary cooking.

### Examples

Next, the present invention will be described in more detail with reference to Examples, Comparative Examples, and Reference Examples, but the present invention is not limited thereto. In the following description, “%” indicates % by mass unless otherwise specified.

[Fat and/or Oil Compositions for Rice Cooking (Compositions 1-10)]

Canola salad oil (manufactured by the Nisshin Oillio Group, Ltd.), MCT (triglyceride of caprylic acid: capric acid=75:25 manufactured by the Nisshin Oillio Group, Ltd.), A-173E (“Sunsoft A-173E”: pentaglycerin trioleate with an HLB of 7 manufactured by Taiyo Kagaku Co., Ltd.), and O-50D (“Ryoto Polyglyester O-50D”: decaglycerin pentaoleate with an HLB of 7 manufactured by Mitsubishi Chemical Corporation) were blended in the formulations shown in Table 1 to obtain compositions 1 to 10.

### <Rice Cooking Test>

Milled white rice was immersed in water with a mass of 1.4 times the mass of the milled white rice, for 1 hour. After the immersion, 1 part by mass of the composition was added to 100 parts by mass of the milled white rice and stirred. Thereafter, the rice was cooked with an electric rice cooker (“SR-FC107” manufactured by Panasonic Corporation), and the cooked rice was transferred to a tray, loosened lightly, cooled to 30° C. by a vacuum cooler, and further cooled at 20° C. for 3 hours to obtain an evaluation sample.

### <Physical Properties Measurement>

The evaluation sample was measured for stickiness and adhesion using a texture measuring instrument (“Tensilpresser Lite” manufactured by Taketomo Electric Co., Ltd.). Ten grams of the evaluation sample was packed in a dish (@: 42 mm) attached to the texture measuring instrument and molded using a rice molding jig attached to the texture measuring instrument. The “stickiness” and “adhesion” measurements were performed using a cylindrical probe (contact area 2.5 cm2) and a program “Cooked Rice 2×3 Measurement Analysis” attached to the texture measuring instrument. The measurement was performed three times, and the average value is shown in Table 1. Note that a higher numerical value of “stickiness” suggests strong stickiness, and a higher numerical value of “adhesion” suggests strong adhesion.

### <Sensory Evaluation>

The evaluation sample was evaluated by a flavor profile method (five trained panels make a tasting and evaluation and exchange opinions to make a comprehensive evaluation). The evaluation contents are as follows, and the results are shown in Table 1.

### (Stickiness)

The evaluation was made in 1 to 5 points; 1 point was given to a rice mass having the strongest stickiness and 5 points was given to a rice mass having the lowest stickiness. Three or more evaluation points were determined as being the rice mass having appropriate stickiness.

### (Taste)

A sample having no off-taste was evaluated as “O”, and a sample having off-taste was evaluated as “X”.

TABLE 1

| | | Component ratio of fat and/or | | | | | (Physical |
|---|---|---|---|---|---|---|---|
| | | oil composition % by mass | | | | (Functionality) | property) |
| | | Canola | | | | Stickiness/ | Stickiness/ |
| | | oil | MCT | A-173E | 0-50D | taste | taste |
| Comparative | Composition | 99 | — | 1 | — | 2/∘ | 45.9/31.9 |
| Example 1 | 1 | | | | | | |
| Comparative | Composition | 90 | 10 | — | — | 1/∘ | 53.2/38.4 |
| Example 2 | 2 | | | | | | |
| Example 1 | Composition | 89 | 10 | 1 | — | 5/∘ | 33.8/13.2 |
| | 3 | | | | | | |
| Example 2 | Composition | 85 | 14 | 1 | — | 5/∘ | 36.0/26.7 |
| | 4 | | | | | | |
| Comparative | Composition | 99 | — | — | 1 | 2/∘ | 47.3/25.6 |
| Example 3 | 5 | | | | | | |
| Example 3 | Composition | 94 | 5 | — | 1 | 4/∘ | 39.2/14.5 |
| | 6 | | | | | | |
| Example 4 | Composition | 89 | 10 | — | 1 | 4/∘ | 38.1/28.7 |
| | 7 | | | | | | |
| Example 5 | Composition | 85.3 | 14 | — | 0.7 | 3/∘ | 40.5/34.8 |
| | 8 | | | | | | |
| Example 6 | Composition | 83 | 14 | — | 3 | 5/∘ | 36.6/26.6 |
| | 9 | | | | | | |
| Comparative | Composition | 81 | 14 | — | 5 | 5/x | 24.7/15.9 |
| Example 4 | 10 | | | | | | |

As is apparent from the results of Table 1, in Examples 1 to 6 containing a certain amount of a triglyceride including medium chain fatty acid as the constituent fatty acid and a certain amount of a polyglycerin fatty acid ester, the stickiness was reduced and the flavor was also good. It was confirmed from comparison between the “stickiness” and the “adhesion” that they are not necessarily correlated.

1. A fat and/or oil composition for rice cooking, comprising 2 to 14% by mass of a triglyceride and 0.6 to 4% by mass of a polyglycerin fatty acid ester,
wherein the triglyceride comprises at least one medium chain fatty acid as a constituent fatty acid and
the at least one medium chain fatty acid is a linear saturated fatty acid having 6 to 12 carbon atoms.

2. The fat and/or oil composition for rice cooking according to claim 1, wherein the polyglycerin fatty acid ester is a polyglycerin fatty acid ester having a hydrophilic hydrophobic balance (HLB) of 3 to 8.

3. The fat and/or oil composition for rice cooking according to claim 1, wherein 50% by mass or more of the constituent fatty acid of the polyglycerin fatty acid ester is an unsaturated fatty acid having 16 to 22 carbon atoms and the constituent polyglycerin has a degree of polymerization of 4 to 12.

4. The fat and/or oil composition for rice cooking according to claim 1, wherein the at least one medium chain fatty acid consists of a linear saturated fatty acid having 8 carbon atoms and/or a linear saturated fatty acid having 10 carbon atoms.

5. The fat and/or oil composition for rice cooking according to claim 1, wherein the fat and/or oil in the fat and/or oil composition for rice cooking is liquid at 10° C.

6. The fat and/or oil composition for rice cooking according to claim 1, wherein the fat and/or oil composition for rice cooking is for cooked rice.

7. Cooked rice comprising the fat and/or oil composition for rice cooking according to claim 1.

8. A method for producing cooked rice, comprising adding 0.1 to 5% by mass of the fat and/or oil composition for rice cooking according to claim 1 to raw cereals before cooked.

9. The fat and/or oil composition for rice cooking according to claim 2, wherein 50% by mass or more of the constituent fatty acid of the polyglycerin fatty acid ester is an unsaturated fatty acid having 16 to 22 carbon atoms and the constituent polyglycerin has a degree of polymerization of 4 to 12.

10. The fat and/or oil composition for rice cooking according to claim 2, wherein the at least one medium chain fatty acid consists of a linear saturated fatty acid having 8 carbon atoms and/or a linear saturated fatty acid having 10 carbon atoms.

11. The fat and/or oil composition for rice cooking according to claim 2, wherein the fat and/or oil in the fat and oil composition for rice cooking is a liquid at 10° C.

12. The fat and/or oil composition for rice cooking according to claim 2, wherein the fat and/or oil composition for rice cooking is for cooked rice.

13. The fat and/or oil composition for rice cooking according to claim 3, wherein the at least one medium chain fatty acid consists of a linear saturated fatty acid having 8 carbon atoms and/or a linear saturated fatty acid having 10 carbon atoms.

14. The fat and/or oil composition for rice cooking according to claim 3, wherein the fat and/or oil in the fat and oil composition for rice cooking is a liquid at 10° C.

15. The fat and/or oil composition for rice cooking according to claim 3, wherein the fat and/or oil composition for rice cooking is for cooked rice.
